(19) United States
(12) Patent Application Publication
(10) Pub. No.: US 2018/0224859 A1
(43) Pub. Date: Aug. 9, 2018

(54) Tornado Detection Systems And Methods

(71) Applicant: Ford Global Technologies, LLC, Dearborn, MI (US)

(72) Inventors: Alexander Brudner, Chicago, IL (US); Scott Vincent Myers, Camarillo, CA (US); Iman Soltani Bozchalooi, Sunnyvale, CA (US)

(21) Appl. No.: 15/427,612

(22) Filed: Feb. 8, 2017

(51) Int. Cl. G05D 1/02; G05D 1/00; G01W 1/10; G01W 1/02; G01S 13/58; G01S 17/58; G06N 3/02

(52) U.S. Cl. CPC G05D 1/0214; G05D 1/0088; G01W 1/10; G01W 2203/00; G01S 13/58; G01S 17/58; G06N 3/02; G01W 1/02

(57) ABSTRACT

Example tornado detection systems and methods are described. In one implementation, a method receives data from a sensor mounted to a vehicle and analyzes the received data using a deep neural network. The method determines whether a tornado is identified in the received data based on the analysis of the received data. If a tornado is identified in the received data, the method determines a trajectory of the tornado.

### TECHNICAL FIELD

The present disclosure relates to vehicular systems and, more particularly, to systems and methods that detect tornadoes near a vehicle.

### BACKGROUND

Automobiles and other vehicles provide a significant portion of transportation for commercial, government, and private entities. Vehicles, such as autonomous vehicles, drive on roadways that may experience structural decay and other problems that put vehicles, and their occupants, at risk. In some situations, a vehicle may be at risk in driving situations where tornadoes and other severe weather conditions are present. For example, tornadoes pose a significant risk to vehicles that get too close to the tornado. Early detection of nearby tornadoes gives the vehicle time to take action to avoid the tornado or take cover.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an embodiment of a vehicle control system that includes a tornado detection system.

FIG. 2 is a block diagram illustrating an embodiment of a tornado detection system.

FIG. 3 illustrates an embodiment of a roadway with multiple vehicles traveling in the same direction.

FIG. 4 illustrates an embodiment of a method for detecting a tornado near a vehicle.

FIG. 5 illustrates another embodiment of a method for determining a path for a vehicle that avoids a tornado.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

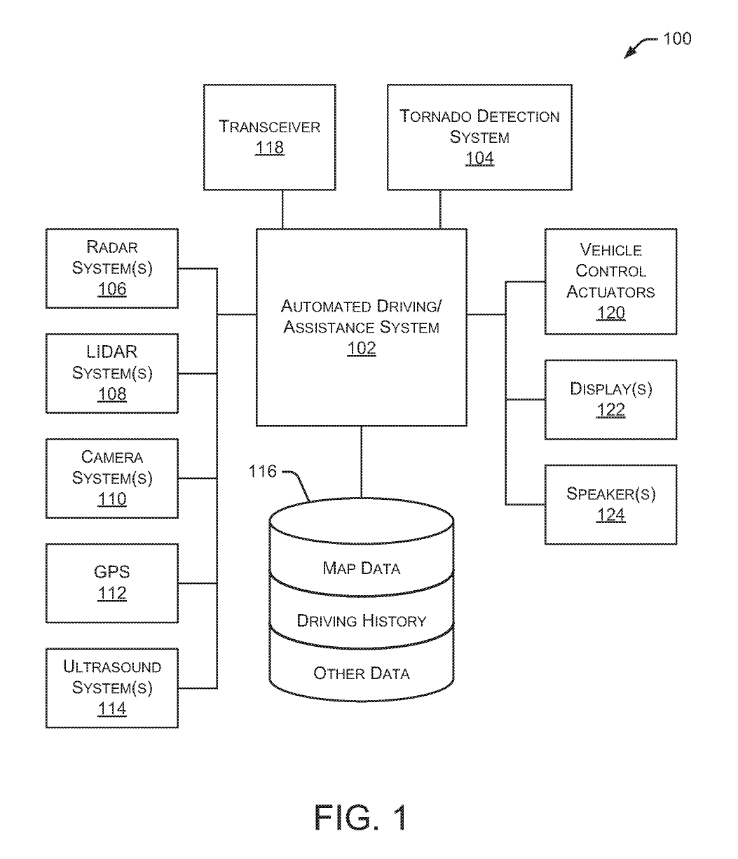

FIG. 1 is a block diagram illustrating an embodiment of a vehicle control system 100 within a vehicle that includes a tornado detection system 104. An automated driving/assistance system 102 may be used to automate or control operation of a vehicle or to provide assistance to a human driver. For example, the automated driving/assistance system 102 may control one or more of braking, steering, seat belt tension, acceleration, lights, alerts, driver notifications, radio, vehicle locks, or any other auxiliary systems of the vehicle. In another example, the automated driving/assistance system 102 may not be able to provide any control of the driving (e.g., steering, acceleration, or braking), but may provide notifications and alerts to assist a human driver in driving safely. Vehicle control system 100 includes tornado detection system 104 that interacts with various components in the vehicle control system to detect and respond to tornadoes near the vehicle. In one embodiment, tornado detection system 104 detects a tornado located near the vehicle and adjusts one or more vehicle operations to avoid the tornado or take cover from the tornado, such as driving away from the tornado or maneuvering the vehicle to a natural or man-made windbreak that may provide protection from the tornado. For example, a roadway underpass, earthen depression or other natural ground formation can provide some protection from the tornado to the vehicle. Although tornado detection system 104 is shown as a separate component in FIG. 1, in alternate embodiments, tornado detection system 104 may be incorporated into automated driving/assistance system 102 or any other vehicle component.

The vehicle control system 100 also includes one or more sensor systems/devices for detecting a presence of nearby objects or determining a location of a parent vehicle (e.g., a vehicle that includes the vehicle control system 100). For example, the vehicle control system 100 may include radar systems 106, one or more LIDAR systems 108, one or more camera systems 110, a global positioning system (GPS) 112, and/or ultrasound systems 114. The one or more camera systems 110 may include a rear-facing camera mounted to the vehicle (e.g., a rear portion of the vehicle), a front-facing camera, and a side-facing camera. Camera systems 110 may also include one or more interior cameras that capture images of passengers and other objects inside the vehicle. The vehicle control system 100 may include a data store 116 for storing relevant or useful data for navigation and safety, such as map data, driving history, or other data. The vehicle control system 100 may also include a transceiver 118 for wireless communication with a mobile or wireless network, other vehicles, infrastructure, or any other communication system.

The vehicle control system 100 may include vehicle control actuators 120 to control various aspects of the driving of the vehicle such as electric motors, switches or other actuators, to control braking, acceleration, steering, seat belt tension, door locks, or the like. The vehicle control system 100 may also include one or more displays 122, speakers 124, or other devices so that notifications to a human driver or passenger may be provided. A display 122 may include a heads-up display, dashboard display or indicator, a display screen, or any other visual indicator, which may be seen by a driver or passenger of a vehicle. The speakers 124 may include one or more speakers of a sound system of a vehicle or may include a speaker dedicated to driver or passenger notification.

It will be appreciated that the embodiment of FIG. 1 is given by way of example only. Other embodiments may include fewer or additional components without departing from the scope of the disclosure. Additionally, illustrated components may be combined or included within other components without limitation.

In one embodiment, the automated driving/assistance system 102 is configured to control driving or navigation of a parent vehicle. For example, the automated driving/assistance system 102 may control the vehicle control actuators 120 to drive a path on a road, parking lot, driveway or other location. For example, the automated driving/assistance system 102 may determine a path based on information or perception data provided by any of the components 106-118. A path may also be determined based on a route that maneuvers the vehicle away from a tornado located near the vehicle. The sensor systems/devices 106-110 and 114 may be used to obtain real-time sensor data so that the automated driving/assistance system 102 can assist a driver or drive a vehicle in real-time.

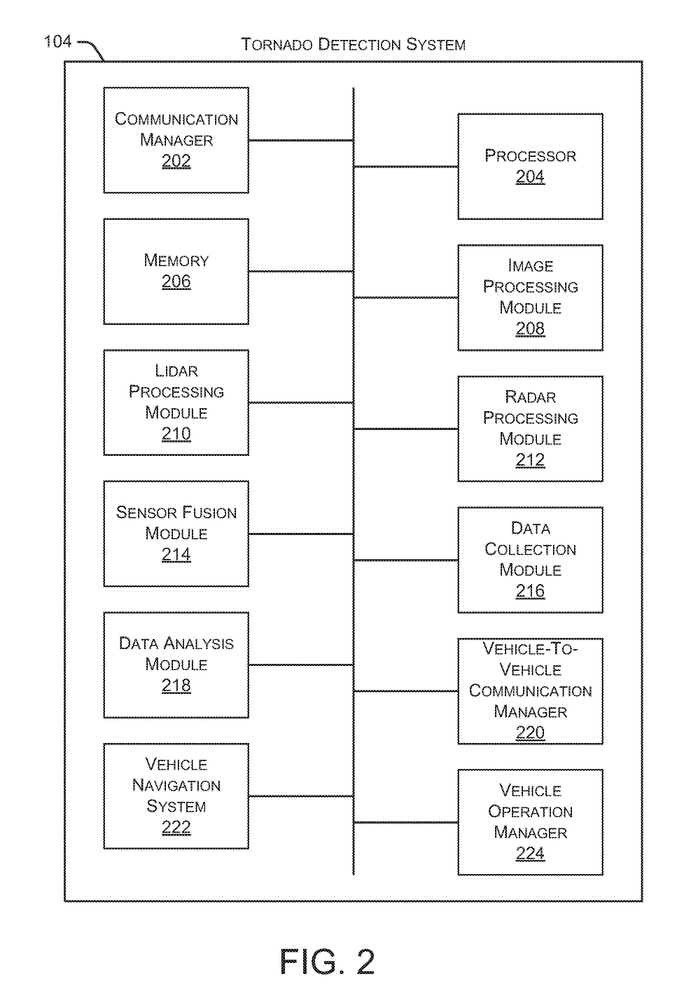

FIG. 2 is a block diagram illustrating an embodiment of tornado detection system 104. As shown in FIG. 2, tornado detection system 104 includes a communication manager 202, a processor 204, and a memory 206. Communication manager 202 allows tornado detection system 104 to communicate with other systems, such as automated driving/assistance system 102. Processor 204 executes various instructions to implement the functionality provided by tornado detection system 104 as discussed herein. Memory 206 stores these instructions as well as other data used by processor 204 and other modules and components contained in tornado detection system 104.

Additionally, tornado detection system 104 includes an image processing module 208 that receives image data from one or more camera systems 110 and identifies, for example, other vehicles moving on a roadway, a tornado located near the vehicle or airborne particles moving in the wind created by a nearby tornado. Example airborne particles include dirt particles, vegetation particles, trash particles, small objects, and any other item or particle that may be blown or moved by wind. In some embodiments, image processing module 208 includes a tornado detection algorithm that identifies a trajectory and speed of a tornado near the vehicle. A LIDAR processing module 210 receives LIDAR data from one or more LIDAR systems 108 and identifies, for example, tornadoes and airborne particles. In some embodiments, the tornado detection algorithm detects the trajectory and speed of a tornado based on LIDAR data. Additionally, a radar processing module 212 receives radar data from one or more radar systems 106 to identify, for example, tornadoes and airborne particles near the vehicle. In some embodiments, the tornado detection algorithm uses the radar data to detect the trajectory and speed of a tornado located near the vehicle. For example, Doppler radar can detect and track tornadoes using airborne debris picked up by the winds associated with a tornado. Additionally, Doppler radar can detect and track rain or hail near the tornado.

Tornado detection system 104 also includes a sensor fusion module 214 that fuses data from multiple sensors, cameras, and data sources, as discussed herein. For example, sensor fusion module 214 may fuse data from one or more cameras 110, radar systems 106, and LIDAR systems 108 to detect tornadoes and airborne particles near a vehicle. A data collection module 216 collects data from multiple sources, such as image processing module 208, LIDAR processing module 210, radar processing module 212, sensor fusion module 214, and other vehicle components, such as an accelerometer, gyroscope, and the like. The accelerometer and gyroscope information is useful, for example, to detect pitch and yaw movements that may be caused by high winds near the vehicle.

Additionally, data collection module 216 may receive (or access) data from additional data sources, such as map data associated with roads near the vehicle's current geographic location, weather data in the current geographic location, current weather warnings (e.g., tornado warnings or tornado watches) and any other type of data from any data source. The map data is useful to identify, for example, upcoming roadway orientation, nearby windbreaks (both natural and man-made), and other areas that can provide protection from a nearby tornado. Other data may include, for example, data from other vehicles or infrastructure systems that report tornadoes near the vehicle's current geographic location. In some embodiments, sound sensors (e.g., microphones) are used to detect and track tornadoes using triangulation of multiple sound sensors or forming a beam from two or more microphones. For example, the microphones may be placed on a single vehicle along a horizontal or vertical line or placed in a combination of the two directions. The spacing between the microphones and the number of microphones determine the precision of the system in detecting and localizing one or more tornadoes.

Tornado detection system 104 further includes a data analysis module 218 that performs various operations on data received from any number of sensors and/or data sources to detect tornadoes, as discussed herein. For example, data analysis module 218 can analyze one or more types of data from image processing module 208, LIDAR processing module 210, radar processing module 212, sensor fusion module 214, data collection module 216, or any other source of data. In some embodiments, tornadoes are detected based on a wind speed, wind direction (e.g., circular movement of the wind), airborne particles, and the like. In particular implementations, data analysis module 218 applies a tornado detection algorithm that can identify tornadoes and determine the speed and trajectory of an identified tornado. In some embodiments, data analysis module 218 uses a deep neural network (DNN) to detect and classify tornadoes based on the various analyzed data. For example, DNN classification may be limited to an is/is-not decision using SVM (Support Vector Machine) classification, or any other method. Pictures that represent tornadoes and pictures that are not tornadoes are fed into the DNN learning process until the SVM reaches a percentage classification (percentage correct) that is considered acceptable. In some embodiments, the system errs on the safe side (e.g., a high percentage correct) since tornadoes are very destructive and relatively rare and short lived. Similarly, existing sound recordings of tornadoes can be used to provide DNN with training material and use microphone readings to detect tornadoes.

Additionally, tornado detection system 104 includes a vehicle-to-vehicle communication manager 220 that allows multiple vehicles to communicate with one another. For example, a vehicle may communicate information regarding a detected tornado (e.g., the location, trajectory, and speed of the tornado) to other nearby vehicles. In some embodiments, a vehicle can communicate information regarding the detected tornado to an infrastructure system using a V2X (Vehicle-to-Infrastructure) communication system.

A vehicle navigation system 222 contains or accesses map data that is used to navigate the vehicle on various roadways. In some embodiments, vehicle navigation system 222 determines a path for the vehicle to avoid a detected tornado. For example, vehicle navigation system 222 may use the map data to find a path (using nearby roads) that is orthogonal to the trajectory of the tornado and leads the vehicle away from the tornado. In some embodiments, vehicle navigation system 222 may find paths (or portions of a path) that do not use roads. For example, a particular path may include driving across a field, parking lot, or any other area necessary to move the vehicle away from the tornado.

Tornado detection system 104 also includes a vehicle operation manager 224 that manages the operation of a vehicle based on the detection of a tornado. In some embodiments, the vehicle may be maneuvered based on the path determined by vehicle navigation system 222. In other embodiments, vehicle operation manager 224 generates recommendations for maneuvering the vehicle to find a natural or man-made windbreak. Vehicle operation manager 224 may cause the vehicle to resume normal driving activities after the danger associated with the tornado has passed.

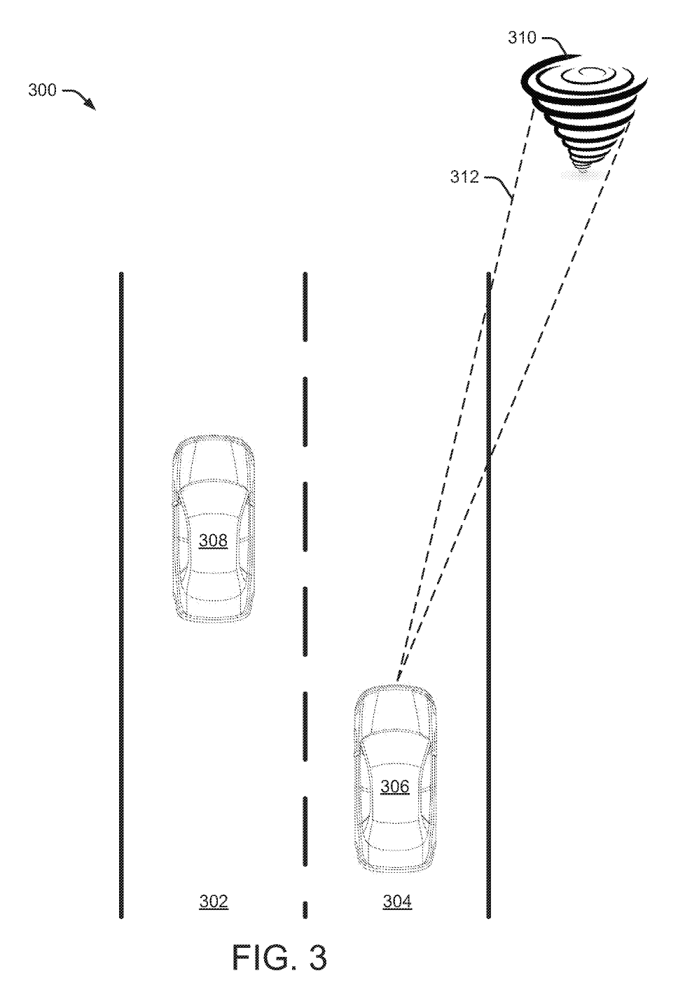

FIG. 3 illustrates an embodiment of a roadway 300 with multiple vehicles traveling in the same direction. In the example of FIG. 3, roadway 300 has two lanes 302 and 304 with traffic moving in the same direction. Two vehicles 306 and 308 are driving on roadway 300. Vehicle 306 is driving in lane 304 and vehicle 308 is driving in lane 302. As shown in FIG. 3, a tornado 310 is located ahead of vehicles 306 and 308. As discussed herein, tornado 310 can be detected based on data from one or more sensors or other data sources. In some embodiments, one or more sensors mounted to vehicle 306 receive data (indicated by broken lines 312) associated with tornado 310. The received data allows tornado detection system 104 to detect tornado 310 as well as the location, trajectory, and speed of tornado 310. As discussed herein, information regarding the location, trajectory, and speed of tornado 310 is used to plan a path to maneuver the vehicle away from the tornado.

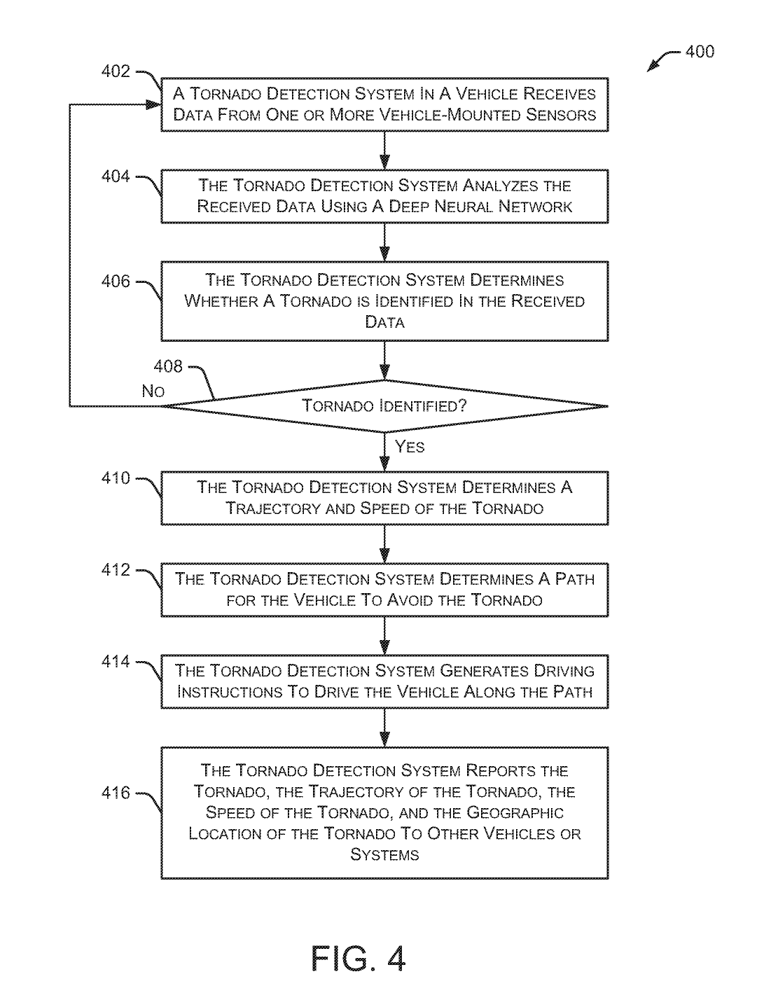

FIG. 4 illustrates an embodiment of a method 400 for detecting a tornado near a vehicle. Initially, a tornado detection system in a vehicle receives 402 data from one or more vehicle-mounted sensors. As discussed herein, various types of vehicle-mounted sensors may be used to collect data regarding the environment near the vehicle, such as LIDAR sensors, radar sensors, cameras, and the like. The tornado detection system analyzes 404 the received data using a deep neural network and determines 406 whether a tornado is detected in the received data.

If a tornado is not identified 408, method 400 continues receiving 402 data to monitor the environmental conditions near the vehicle. In some embodiments, data from a LIDAR system includes a three-dimensional point cloud of airborne particles in the wind. This data is provided to the deep neural network to detect and classify a tornado near the vehicle. For example, tornadoes can be classified based on an F-Scale or Fujita Scale, which classifies tornadoes based on their estimated wind speed. In some embodiments, tornadoes are classified into five categories, F-0 through F-5, where F-0 tornadoes are the mildest and F-5 tornadoes are the most dangerous. In some embodiments of the systems and methods discussed herein, a DNN classifier would identify a tornado and wind speed can be measured using LIDAR, radar, bending of trees, buffeting of the vehicle, wind noise, anemometers, crowd sourcing, and the like. When a tornado is identified, all movable objects can take action and move to a safer place if the movable object is autonomous in nature. This includes road vehicles as well as farm equipment, cranes, and other equipment.

In particular implementations, other sensor data (e.g., camera images or radar data) is used to detect airborne particles. If a tornado is identified 408, the tornado detection system determines 410 a trajectory and speed of the tornado. In some embodiments, the trajectory and speed of the tornado are determined by tracking the movement of the tornado over a period of time. For example, data from one or more vehicle sensors can be analyzed at different times (e.g., a few seconds or a few minutes apart) to determine the speed at which the tornado is moving and the approximate direction of movement. The tornado detection system then determines 412 a path for the vehicle to follow that will avoid the tornado. In some embodiments, the tornado detection system identifies a path, using map data, that is substantially orthogonal to the trajectory of the tornado and that moves the vehicle away from the tornado. For example, the path considers the distance and direction of the path as compared to the tornado's current speed and trajectory. Since tornadoes typically change speed and direction regularly, the path must account for significant changes in the tornado's current speed and trajectory to be certain the vehicle maintains a safe distance from the tornado if the tornado changes speed or direction.

The tornado detection system generates 414 driving instructions to drive the vehicle along the path. Additionally, the tornado detection system reports 416 the existence of the tornado, the trajectory of the tornado, the speed of the tornado, and the geographic location of the tornado to other vehicles or systems. Any type of communication system, such as V2V (vehicle-to-vehicle) or V2X (vehicle-to-infrastructure), can be used to report the tornado and associated information to other vehicles or systems. For example, referring to FIG. 3, if vehicle 306 detects tornado 310, it may communicate the existence of the tornado and information associated with the tornado to vehicle 308 using a V2V communication system. In some embodiments, a vehicle driver or passenger can report (or confirm) the existence of a tornado and the approximate location of the tornado relative to the vehicle.

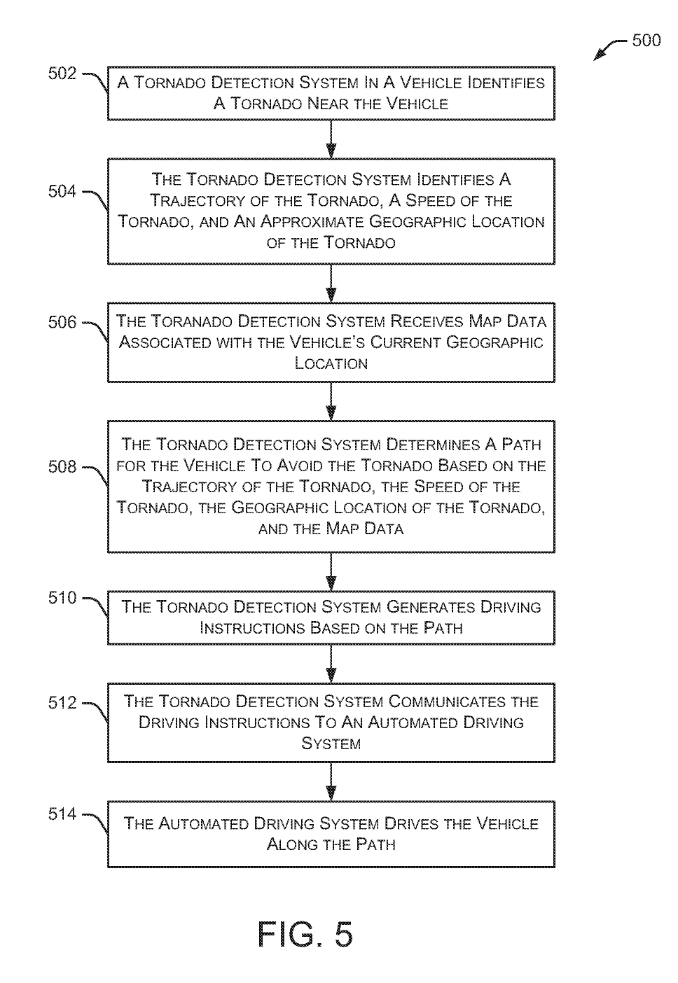

FIG. 5 illustrates another embodiment of a method 500 for determining a path for a vehicle that avoids a tornado. Initially, a tornado detection system in a vehicle identifies 502 a tornado near the vehicle using the systems and methods discussed herein. The tornado detection system identifies 504 a trajectory of the tornado, a speed of the tornado, and an approximate geographic location of the tornado. In some embodiments, method 500 identifies the approximate location of the tornado based on the known location of the vehicle (e.g., using the vehicle's global positioning system). The tornado detection system also receives 506 map data associated with the vehicle's current geographic location. The map data may be stored within the vehicle (e.g., as part of the vehicle's navigation system) or accessed from another data source, such as a map database external to the vehicle.

Method 500 continues as the tornado detection system determines 508 a path for the vehicle to avoid the tornado based on the trajectory of the tornado, the speed of the tornado, the geographic location of the tornado, and the map data. As discussed herein, the path may be orthogonal to the trajectory of the tornado and may direct the vehicle away from the tornado. Additionally, the tornado detection system generates 510 driving instructions based on the path. These driving instructions can be communicated 512 to an automated driving system that implements the appropriate actions to drive 514 the vehicle along the path. In some embodiments, the driving instructions are provided to a driver or passenger of the vehicle. For example, the driving instructions may be visual instructions provided on a display device, such as a display device used with a vehicle navigation system. Alternatively, the driving instructions may be audible instructions provided to the driver or passenger of the vehicle through a speaker or similar device.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
receiving data from a sensor mounted to a vehicle;
analyzing the received data using a deep neural network;
determining, by a tornado detection system in the vehicle, whether a tornado is identified in the received data based on the analysis of the received data; and
responsive to determining that a tornado is identified in the received data, determining a trajectory of the tornado.

2. The method of claim 1, wherein the sensor mounted to the vehicle includes at least one of a LIDAR sensor, a radar sensor, and a camera.

3. The method of claim 1, further comprising determining, by the tornado detection system in the vehicle, a path for the vehicle to avoid the tornado based on the trajectory of the tornado.

4. The method of claim 3, wherein determining a path for the vehicle to avoid the tornado is substantially orthogonal to the trajectory of the tornado.

5. The method of claim 3, wherein determining a path for the vehicle to avoid the tornado is substantially leading away from the trajectory of the tornado.

6. The method of claim 3, further comprising generating driving commands to drive the vehicle along the path.

7. The method of claim 1, further comprising determining, by the tornado detection system in the vehicle, a path for the vehicle to avoid the tornado based on the trajectory of the tornado, a speed of the tornado, a geographic location of the tornado, and map data.

8. The method of claim 1, wherein the vehicle is an autonomous vehicle.

9. The method of claim 1, further comprising reporting the approximate location of the tornado and the trajectory of the tornado to other nearby vehicles.

10. The method of claim 1, further comprising reporting the approximate location of the tornado and the trajectory of the tornado to an infrastructure-based system.

11. The method of claim 1, further comprising generating audible or visual warnings indicating the existence of the tornado.

12. The method of claim 1, further comprising generating audible or visual driving instructions to maneuver the vehicle to avoid the tornado.

13. A method comprising:
receiving data from a plurality of sensors mounted to a vehicle;
analyzing the received data using a deep neural network;
determining, by a tornado detection system in the vehicle, whether a tornado is identified in the received data based on the analysis of the received data; and
responsive to determining that a tornado is identified in the received data:
determining a trajectory of the tornado;
determining a speed of the tornado; and
determining a geographic location of the tornado.

14. The method of claim 13, wherein the plurality of sensors mounted to the vehicle include at least one of a LIDAR sensor, a radar sensor, and a camera.

15. The method of claim 13, wherein the determining of the trajectory of the tornado and the speed of the tornado is based on the analysis of the received data.

16. The method of claim 13, further comprising determining, by the tornado detection system in the vehicle, a path for the vehicle to avoid the tornado based on the trajectory of the tornado, the speed of the tornado, and the geographic location of the tornado.

17. The method of claim 16, further comprising generating driving commands to drive the vehicle along the path.

18. The method of claim 13, further comprising reporting the trajectory of the tornado, the speed of the tornado, and the geographic location of the tornado to other nearby vehicles.

19. An apparatus comprising:
a sensor mounted to a vehicle and configured to capture sensor data; and
a tornado detection system coupled to the sensor and configured to receive and analyze the sensor data using a deep neural network, the tornado detection system further configured to determine whether a tornado is identified in the sensor data based on the analysis of the sensor data, wherein the tornado detection system is further configured, responsive to identification of a tornado, to:
determine a trajectory of the tornado based on the analysis of the sensor data; and
determine a speed of the tornado based on the analysis of the sensor data.

20. The apparatus of claim 19, wherein the sensor includes one of a LIDAR sensor, a radar sensor, and a camera.
